(19) United States
(12) Patent Application Publication
(10) Pub. No.: US 2025/0178910 A1
(43) Pub. Date: Jun. 5, 2025

(54) METAL SILICIDE AND METHOD FOR PRODUCING SAME, ALLOY MATERIAL AND METHOD FOR PRODUCING SAME, HEATING ELEMENT, AND ELECTRIC RESISTOR

(71) Applicant: TOHOKU UNIVERSITY, Sendai-shi, Miyagi (JP)

(72) Inventors: Takahiro MIKI, Sendai-shi (JP); Jonah Longaquit GAMUTAN, Sendai-shi (JP)

(21) Appl. No.: 18/842,641

(22) PCT Filed: Dec. 27, 2022
(86) PCT No.: PCT/JP2022/048247

§ 371 Date: Aug. 29, 2024

(30) Foreign Application Priority Data
Apr. 8, 2022 (JP) 2022-064491

(51) Int. Cl. C01B 33/06; C23C 22/70

(52) U.S. Cl. CPC C01B 33/06; C23C 22/70; C01P 2002/72; C01P 2004/03

(57) ABSTRACT

A metal silicide according to an embodiment of the present invention is a metal silicide containing an element M. The metal silicide contains, in mass %, 0.001 to 10% of an element X, where the element X is one or more selected from the group consisting of Sn, Ag, Au, Bi, Pb, and Cu, and the element M is Mo or W.

### CROSS-REFERENCE TO RELATED APPLICATIONS

This application is the U.S. National Stage entry of International Application No. PCT/JP2022/048247, filed on Dec. 27, 2022, which, in turn, claims priority to Japanese Patent Application No. 2022-064491, filed on Apr. 8, 2022, both of which are hereby incorporated herein by reference in their entireties for all purposes.

### TECHNICAL FIELD

The present invention relates to a metal silicide and a method for producing the same, an alloy material and a method for producing the same, a heating element, and an electric resistor.

### BACKGROUND ART

A molybdenum-based alloy (Mo-based alloy) is known as a material having excellent heat resistance at high temperatures. However, Mo-based alloys have the disadvantage that they are easily oxidized at high temperatures. Therefore, when the Mo-based alloy is used in a high-temperature environment, it is indispensable to form a protective film on the surface for preventing oxidation.

A MoSi₂ alloy (intermetallic compound) is known as a material effective as such a protective film (for example, Patent Document 1). Since a SiO₂ film is formed on the surface of the MoSi₂ alloy, the progress of oxidation to the inside of the Mo-based alloy can be prevented. The MoSi₂ alloy can be used, for example, even in an oxidizing atmosphere at an extremely high temperature exceeding 1500° C., that is, it is very useful as a material having high-temperature oxidation resistance.

As a method for forming a MoSi₂ film on the surface of a Mo-based alloy, a pack cementation method is generally known.

### CITATION LIST

### Patent Document

Patent Document 1: JP H10-017977 A

### Non-Patent Document

Non-Patent Document 1: Jia Sun et al., “Effect of filler on the oxidation protective ability of MoSi2 coating for Mo substrate by halide activated pack cementation” Materials & Design Volume 92, 15 Feb. 2016, Pages 602-609.
Non-Patent Document 2: S. Majumdar “Formation of MoSi2 and Al doped MoSi2 coatings on molybdenum base TZM (Mo-0.5Ti-0.1Zr-0.02C) alloy” Surface and Coatings Technology Volume 206, Issue 15, 25 Mar. 2012, Pages 3393-3398.

### SUMMARY OF INVENTION

### Technical Problem

However, although the pack cementation method which is generally used can stably form the MoSi₂ film, it has a problem in that the treatment conditions are severe. Specifically, in the case of the pack cementation method, the treatment time required is very long, for example, from about 10 to 18 hours, and the treatment must be performed in a very high temperature range of from about 1100 to 1300° C. (see Non-Patent Documents 1 and 2). Therefore, the load on the equipment to be used has also been a problem.

In addition, the pack cementation method is a treatment in which a metal material (base material) to be silicided is embedded in a crucible filled with powder for pack cementation and heated at a predetermined temperature to silicide the surface of the base material. Therefore, temperature unevenness often occurs in the surface part of the base material, and there are cases where the film thickness of the obtained silicide film becomes uneven.

From such a background, in a method for producing a MoSi₂ alloy including a method for forming a MoSi₂ film on a surface of the Mo-based alloy, there is a demand for a method capable of obtaining a MoSi₂ alloy having excellent high-temperature oxidation resistance and improving production efficiency such as shortening of a high-temperature treatment time and lowering of a treatment temperature.

In view of the aforementioned circumstances, an object of the present invention is to provide a metal silicide having excellent oxidation resistance and a method for producing the same, an alloy material and a method for producing the same, a heating element, and an electric resistor.

### Solution to Problem

The present inventors first focused on the composition of a Si bath in which a Mo-based alloy is immersed, and studied the design of the bath composition from the viewpoint of achieving both of an improvement in the high-temperature oxidation properties of the obtained MoSi₂ alloy and an improvement in the production efficiency. As a result, it was found that by using a molten Sn—Si alloy bath obtained by containing Si in a Sn bath, a MoSi₂ alloy having excellent high-temperature oxidation properties can be obtained, and shortening of the treatment time (immersion time) and lowering of the treatment temperature (bath temperature) can be achieved. In addition, the same investigation was conducted using a tungsten-based alloy (W-based alloy) as another heat-resistant material, and it was found that even when a W-based alloy was used, a MoSi₂ alloy having excellent high-temperature oxidation properties was obtained, and an improvement in production efficiency could be achieved.

Furthermore, as a result of investigation of the composition of the Si bath, it has been found that Ag, Au, Bi, Pb, and Cu, other than Sn, have the same action and effect as described above as an additive element to the bath.

The present invention has been made on the basis of the aforementioned findings, and can be summarized as follows.

[1]A metal silicide according to a first embodiment of the present invention is a metal silicide containing an element M, the metal silicide further containing, in mass %, from 0.001 to 10% of an element X, wherein the element X is one or more selected from the group consisting of Sn, Ag, Au, Bi, Pb, and Cu, and the element M is Mo or W.

[2] In the metal silicide according to [1], the element X may be Sn.

[3]A method for producing a metal silicide according to a second embodiment of the present invention is a method for producing the metal silicide according to the [1] above, the method including an immersion step of immersing a Mo-based alloy material or a W-based alloy material in a treatment bath containing Si and the element X, wherein the treatment bath has a bath temperature of from 200 to 1500° C., and the treatment bath has a composition containing from 0.001 to 99.99 mass % of Si, with a remainder thereof being the element X.

[4] In the method for producing a metal silicide according to [3], the element X may be Sn.

[5] The method for producing a metal silicide according to [3] or [4] may further include, before the immersion step, a pre-forming step of forming the Mo-based alloy material or the W-based alloy material.

[6] An alloy material according to a third embodiment of the present invention includes a base material, and a film formed on a surface of the base material, the film being made of a metal silicide containing an element M, wherein the metal silicide contains, in mass %, from 0.001 to 10% of an element X, the element X is one or more selected from the group consisting of Sn, Ag, Au, Bi, Pb, and Cu, the element M is Mo or W, and the base material is a Mo-based alloy material or a W-based alloy material.

[7] In the alloy material according to [6], the element X may be Sn.

[8]A method for producing an alloy material according to a fourth embodiment of the present invention is a method for producing the alloy material according to [6] above, the method including an immersion step of immersing the base material in a treatment bath containing Si and the element X, wherein the treatment bath has a bath temperature of from 200 to 1500° C., and the treatment bath has a composition containing from 0.001 to 99.99 mass % of Si, with a remainder thereof being the element X.

[9] In the method for producing an alloy material according to [8], the element X may be Sn.

[10] The method for producing an alloy material according to [8] or [9] may further include, before the immersion step, a pre-forming step of forming the base material.

[11]A heating element according to a fifth embodiment of the present invention contains the metal silicide according to [1] or [2] above.

[12] An electric resistor according to a sixth embodiment of the present invention contains the metal silicide according to [1] or [2] above.

### Advantageous Effects of Invention

According to the present invention, it is possible to provide a metal silicide having excellent oxidation resistance and a method for producing the same, an alloy material and a method for producing the same, a heating element, and an electric resistor. In addition, according to the method for producing a metal silicide and the method for producing an alloy material of the present invention, the treatment time can be shortened and the treatment temperature can be lowered, whereby the production efficiency can be remarkably improved.

### BRIEF DESCRIPTION OF DRAWINGS

FIG. 1 is a schematic cross-sectional view of an immersion apparatus used in an example.

FIG. 2 shows SEM images of a surface layer of a Mo alloy material in the example.

FIG. 3 shows SEM images of a surface layer of a Mo alloy material in the example.

FIG. 4 shows SEM images of a surface layer of a Mo alloy material in the example.

FIG. 5 shows SEM images of a surface layer of a Mo alloy material in the example.

FIG. 6 shows photographs showing results of a high-temperature oxidation test in the example.

FIG. 7 shows an SEM image of a sample after high-temperature oxidation test and element mapping results in the example.

FIG. 8 is an SEM image of a sample after a high-temperature oxidation test in the example.

FIG. 9 is an SEM image of a surface layer of a Mo alloy material in Example 2.

FIG. 10 shows element mapping results in Example 2.

FIG. 11 shows diffraction peaks obtained by XRD in Example 2.

FIG. 12 is an SEM image of a surface layer of a Mo alloy material in Example 3.

FIG. 13 shows element mapping results in Example 3.

FIG. 14 shows diffraction peaks obtained by XRD in Example 4.

FIG. 15 is an SEM image of a surface layer of a W alloy material in Example 5.

FIG. 16 shows element mapping results in Example 5.

FIG. 17 shows diffraction peaks obtained by XRD in Example 5.

FIG. 18 is an SEM image of a plate thickness cross section of a Mo silicide in Example 6.

FIG. 19 shows element mapping results in Example 6.

### DESCRIPTION OF EMBODIMENT

A metal silicide and a method for producing the same, an alloy material and a method for producing the same, a heating element, and an electric resistor according to the present embodiment are described below. However, the present invention is not limited to only the configuration disclosed in the present embodiment, and various modifications can be made without departing from the scope of the present invention.

### [Metal Silicide]

First, a metal silicide of the present embodiment will be described in detail below.

The metal silicide of the present embodiment is a metal silicide containing Mo or W (element M). The metal silicide contains, as an element X, from 0.001 to 10 mass % in total of one or more selected from the group consisting of Sn, Ag, Au, Bi, Pb, and Cu.

The metal silicide of the present embodiment is substantially free of components other than Si, the element M, and the element X.

Here, the term “substantially free” encompasses that the presence of impurities to such an extent that the effects and characteristics of the present invention are not impaired is allowed. The impurities are components that are mixed due to various factors in the manufacturing process such as raw materials when the alloy material is industrially manufactured, and examples of the same include components that are inevitably mixed. The content of impurities is preferably as small as possible, but is preferably 0.001 mass % or less in total with respect to the entire metal silicide.

### (Element M: Mo or W)

The metal silicide of the present embodiment is composed of Si, and molybdenum (Mo) or tungsten (W), as main components. That is, the metal silicide of the present embodiment is substantially MoSi₂ or WSi₂, but as will be described later, the element X such as Sn is contained in the metal silicide.

The metal silicide of the present embodiment may be other than MoSi₂ and WSi₂. It may be Mo₅Si₃, W₅Si₃, Mo₃Si, W₃Si, or the like.

### (Element X)

The metal silicide contains, as an element X, from 0.001 to 10 mass % in total of one or more selected from the group consisting of Sn, Ag, Au, Bi, Pb, and Cu. That is, the metal silicide of the present embodiment is in a solid solution in which the element X is dissolved in MoSi₂, for example.

These elements X are components derived from a “molten X—Si alloy bath” in which the element X is added to a molten Si bath, which will be described later. That is, when a metal silicide is produced using a “molten X—Si alloy bath” to be described later, the element X (for example, Sn) in the bath enters the metal silicide (for example, MoSi₂) to form a “solid solution in which the element X is dissolved in MoSi₂”.

When the ratio of the element X in the metal silicide is very small, the characteristics are not affected. However, when the content of the element X is excessively high, another phase may be generated in the metal silicide. Therefore, the total content of the element X is set to be 10 mass % or less. It is preferably 5 mass % or less, and more preferably 3 mass % or less. On the other hand, in the method for producing a metal silicide according to the present embodiment, the molten bath containing the element X is used to improve the production efficiency. In order to obtain this effect, it is necessary to add a certain concentration or more of the element X to the bath. In other words, the lower limit value of the amount of the element X in the obtained metal silicide is a certain amount or more from the viewpoint of improving the production efficiency. Specifically, the total content of the element X in the metal silicide is 0.001 mass % or more. It is preferably 0.01 mass % or more, more preferably 0.1 mass % or more.

The content in the metal silicide can be controlled by adjusting the immersion time in the molten X—Si alloy bath, the bath temperature, and the bath composition.

The element X contained in the metal silicide is one or more selected from the group consisting of Sn, Ag, Au, Bi, Pb, and Cu. That is, the metal silicide may contain two or more of these elements. Note that the element X is preferably Sn in order to secure stable high-temperature oxidation resistance and to obtain an improvement in production efficiency in a well-balanced manner. In other words, the “molten X—Si alloy bath” described below is preferably a molten Sn—Si alloy bath.

### [Alloy Material]

Next, the alloy material according to the present embodiment will be described.

The alloy material of the present embodiment includes a Mo-based alloy material or a W-based alloy material as a base material, and on the base material, a film (metal silicide film) made of the metal silicide according to the present embodiment. That is, similarly to the known pack cementation method, by immersing the Mo-based alloy material or the W-based alloy material in the “molten X—Si alloy bath”, the alloy material in which the metal silicide film is formed on the base material is obtained.

The Mo-based alloy material serving as the base material may be an alloy material in which a desired alloy element is contained in Mo or may be a material of Mo alone (for example, a metal Mo plate) depending on the application. Similarly, the W-based alloy material that is the base material may be an alloy material in which a desired alloy element is contained in W or may be a material of W alone (for example, a metal W plate) depending on the application.

Here, according to the method for producing an alloy material according to the present embodiment described later, the element X (Sn or the like) in the bath may enter the base material side during the immersion. The longer the immersion time, the more element X will enter. The entry of the element X into the base material is not preferable from the viewpoint of lowering the melting point of the base material. Therefore, the average concentration of the element X at a depth of 10 μm from the surface of the base material (from the interface with the metal silicide film) is desirably 1 mass % or less.

The concentration of the element X at a depth of 10 μm from the surface of the base material (from the interface with the metal silicide film) can be controlled by adjusting the immersion time in the molten X—Si alloy bath and the bath temperature.

### [Method for Producing Metal Silicide]

### [Method for Producing Alloy Material]

Next, a method for producing a metal silicide and a method for producing an alloy material of the present embodiment will be described in detail below.

The method for producing a metal silicide of the present embodiment includes an immersion step of immersing a Mo-based alloy material or a W-based alloy material as a base material in a treatment bath (molten X—Si alloy bath) containing Si and the above-described element X.

### (Immersion Step)

First, a Mo-based alloy material (including a Mo plate) or a W-based alloy material (including a W plate) is prepared as a base material, and is immersed in the following treatment bath (molten X—Si alloy bath).

### <Treatment Bath>

Bath temperature: from 200° C. to 1500° C.
Bath composition: from 0.001 to 99.99 mass % of Si is contained, while the remainder is the element X.

The temperature of the treatment bath is set in a range of from 200° C. to 1500° C. If the temperature of the treatment bath is too low, Si may not be molten into the element X. Therefore, the temperature of the treatment bath is set to 200° C. or more, preferably 400° C. or more.

On the other hand, as a result of the study by the inventors of the present invention of the relationship between the temperature of the treatment bath and the state and rate of film formation of the metal silicide film, it was found that it is undesirable if the temperature of the treatment bath is too high. Specifically, it has been found that the film formation rate can be increased as the temperature of the treatment bath is lower.

The mechanism by which the film formation rate increases as the temperature of the treatment bath is lower has not been clarified, but it is presumed that the reason is as follows.

As the temperature of the treatment bath is lower, the element X is more likely to form a solid solution in the metal silicide film, and furthermore, holes are generated in the crystal structure of the metal silicide film, so that Si is more likely to diffuse in the film. As described above, it is considered that the lower the temperature of the treatment bath is, the more the diffusion of Si in the film is promoted, and as a result, the film formation rate of the metal silicide film is increased.

For the reasons described above, in the present embodiment, it is effective to avoid an excessive increase in the temperature of the treatment bath. Specifically, the temperature of the treatment bath is 1500° C. or lower, preferably 1000° C. or lower, and more preferably 900° C. or lower.

The composition of the treatment bath contains from 0.001 to 99.99 mass % of Si, while the remainder is the element X. However, when designing the composition of the treatment bath, it is desirable to consider the solubility of Si in the molten element X at a certain temperature of the treatment bath. Therefore, the composition of the treatment bath is preferably a composition containing from 0.01 to 50 mass % of Si, with the remainder being the element X, and more preferably a composition containing from 0.1 to 20 mass % of Si, with the remainder being the element X.

The treatment bath in the present embodiment may be in a state in which the element X and Si in the bath are all molten, or may be in a state in which a part thereof remains as a solid.

The immersion time in the immersion step may be appropriately determined depending on the target dimension of the target metal silicide film or the like. In addition, in the method of production the present embodiment, as described above, the film formation rate can be increased by adding the element X to the treatment bath. That is, in the pack cementation, which is one of known methods, from about 10 to 20 hours are required for immersion, but in the present embodiment, the immersion time can be shortened by adding the element X to the treatment bath. However, when the immersion time is excessively short, the thickness of the metal silicide film becomes insufficient, and as a result, the high-temperature oxidation resistance of the obtained metal silicide film (or alloy material) may be deteriorated. From such a viewpoint, the immersion time is preferably 1 minute or more.

Here, the metal silicide according to the present embodiment is obtained by forming a sufficiently thick metal silicide film in the immersion step. That is, the metal silicide according to the present embodiment can be obtained by immersing the Mo-based alloy material or the W-based alloy material, which is the base material, in a bath to cause a silicidation reaction over the entire thickness of the base material. On the other hand, the alloy material of the present embodiment can be produced by adjusting the immersion time and allowing a part of the base material to remain.

The atmosphere in the immersion step is not particularly limited, but is preferably an inert gas atmosphere from the viewpoint of oxidation prevention. Examples of the inert gas include argon (Ar) gas and nitrogen (N₂) gas.

In addition, the number of times of immersing the base material may be one or more. From the viewpoint of more stably forming a metal silicide film having a sufficient thickness, the number of times of immersion is preferably two or more. In the case where immersion is performed a plurality of times, the immersion conditions for each time may be the same or may be varied as long as they are within the above-mentioned range. After the immersion step is completed, the element X remaining on a surface of a film thus formed may be removed using an acid or the like.

### (Pre-Forming Step)

In the present embodiment, the method may further include a pre-forming step of forming the Mo-based alloy material or the W-based alloy material as the base material before the immersion step. That is, the Mo-based alloy material or the W-based alloy material immersed in the treatment bath may have various shapes. For example, when the metal silicide of the present embodiment is provided on the surface layer of a component having a desired shape, the Mo-based alloy material or the W-based alloy material serving as the base material may be formed into a shape close to the final shape of the component before the immersion step, and then the formed base material may be subjected to the immersion step. Through such a pre-forming step, an alloy material having a desired shape can be obtained. In addition, by shaping the base material in advance, metal silicides having various shapes can be obtained.

In general, a metal silicide is brittle and difficult to process. However, as in the present embodiment, the pre-forming step makes it possible to form the alloy material or the metal silicide into a predetermined shape close to the final shape in a state of the base material that is easy to process, which makes it possible to obtain the alloy material or the metal silicide having a desired shape.

The shape into which the base material is formed in the pre-forming step is not limited. For example, any of a massive form, a plate form, a linear form, and a fine particle form can be applied.

When the base material is formed into a massive form (a bulk material having a complicated shape), cutting or casting can be applied. When the base material is formed into a plate form, pressing, rolling, bending, punching, or the like can be applied. When the base material is formed into a linear form, bending, twisting, or the like can be applied. When the base material is in a form of fine particles (for example, powder), a molded article molded by 3D printing using fine particles, compression molding, sintering of powder, or the like may be subjected to the immersion step. As the molded article using the base material in the form of fine particles, both a dense material having a complicated shape (or a simple shape) and a non-dense material (having a space therein) are applicable.

A metal silicide and an alloy material having excellent high-temperature oxidation resistance can be produced by the method described above.

In addition, the method of production according to the present embodiment is a method in which an Mo-based alloy material or a W-based alloy material having a relatively high density is used as a base material and is immersed in a molten X—Si alloy bath. That is, when a Mo-based alloy material or a W-based alloy material is used as a base material and applied to the immersion method as described above, a stable operation becomes possible, so that a metal silicide and an alloy material with less quality unevenness can be produced.

In addition, since the method of production according to the present embodiment is an immersion method using a molten X—Si alloy bath, it is possible to further enhance the uniformity of the obtained metal silicide film as compared with the pack cementation method using powder.

Further, in the method of production according to the present embodiment, the metal silicide and the alloy material can be produced only by pulling up a Mo-based alloy material or a W-based alloy material as the base material from a molten X—Si alloy bath after the immersion step. As compared with the pack cementation method in which a product needs to be taken out of powder, a metal silicide and an alloy material can be easily produced.

In addition, powder used in the pack cementation method cannot be used again production. In the method of production according to the present embodiment, it is also possible to reuse the remaining molten X—Si alloy bath after pulling up a Mo-based alloy material or a W-based alloy material as the base material.

### [Application]

Since the metal silicide and the alloy material of the present embodiment have excellent high-temperature oxidation resistance, they are suitable for various heating elements and electric resistors.

### EXAMPLES

Next, the present invention will be described in more detail with reference to Examples and Comparative Examples, but the present invention is not limited to the following Examples as long as it does not exceed the scope thereof. That is, the present invention naturally encompasses other examples, aspects, and the like within the scope of the technical idea of the present invention.

### Example 1

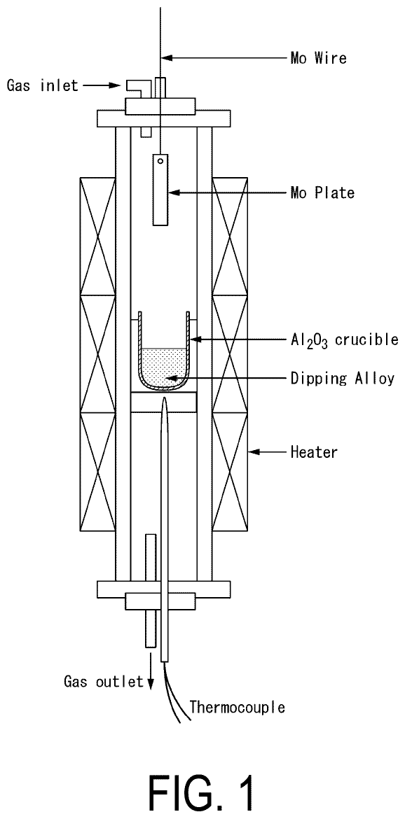

First, using an immersion apparatus shown in FIG. 1, under an Ar gas atmosphere, Sn and Si were charged into a crucible (made of Al₂O₃) and the crucible was heated by a heater to prepare a treatment bath (molten Sn—Si alloy bath) having a composition of 98.8 mass % of Sn and 1.2 mass % of Si.

Next, a metallic Mo plate (50 mm in length, 10 mm in breadth, and 1 mm in thickness) was immersed in the prepared treatment bath with the bath temperature and immersion time adjusted as described below to form a Mo silicide film on the Mo plate, thereby obtaining a Mo-alloy material.

After the Mo silicide film was formed, the immersed Mo plate was lifted up from the treatment bath to remove the unnecessary bath adhering thereto, and then the Mo alloy material was taken out of the immersion apparatus and recovered.
Bath temperature: 700° C., 800° C., 900° C., 1000° C.
Immersion time: 15 minutes, 30 minutes, 60 minutes

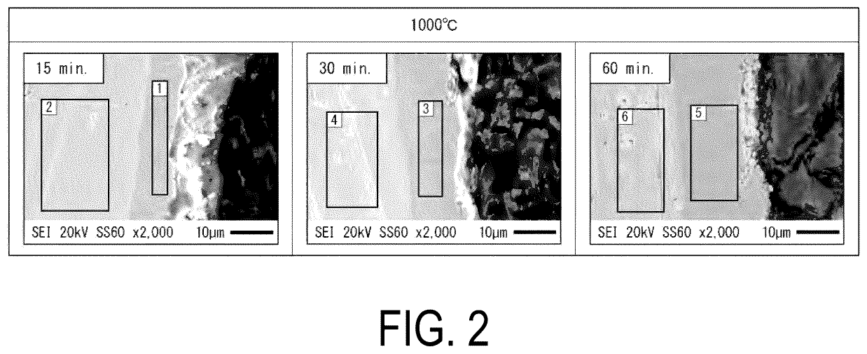

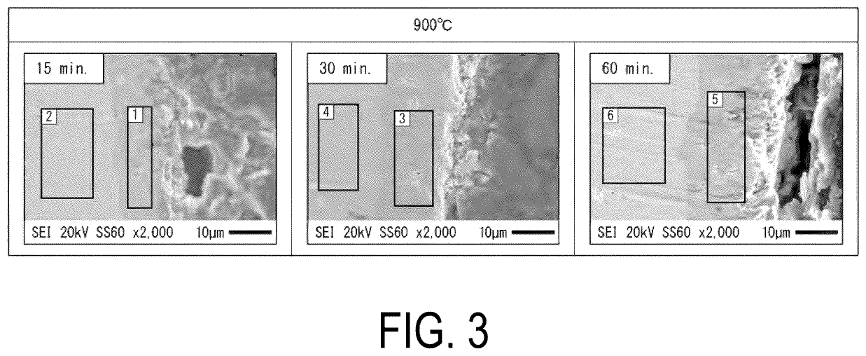

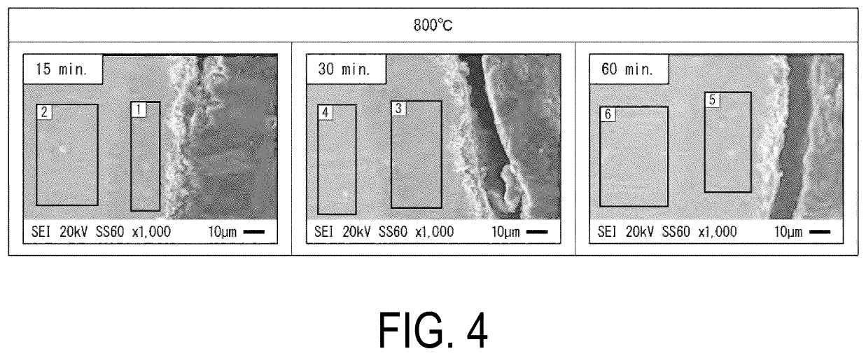

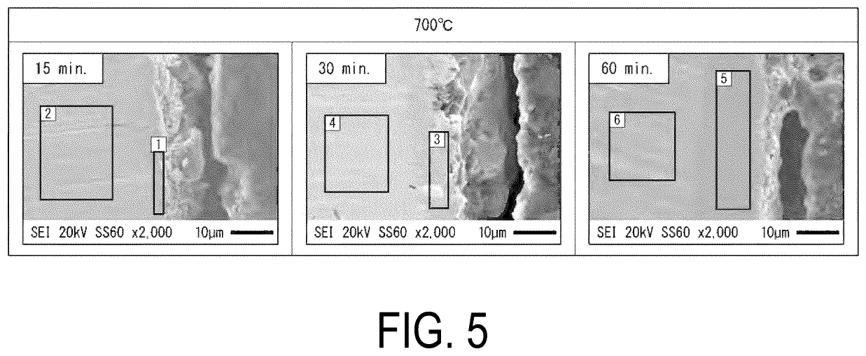

In each of the obtained Mo alloy materials, the surface layer (including the Mo silicide film) was subjected to SEM observation. The results are shown in FIGS. 2 to 5. In addition, energy dispersive X-ray analysis (EDS analysis) was performed on each of regions 1 to 6 of each of the SEM images in FIGS. 2 to 5 to investigate the composition of each region. The results are shown in Tables 1 to 4.

As shown in FIGS. 2 to 5 and Tables 1 to 4, it was found that a Mo silicide film having a sufficient thickness was formed on the surface layer of the Mo alloy material produced by applying the present invention.

TABLE 1

| | | Si | Mo | Sn | |
|---|---|---|---|---|---|
| Time (min) | Area | (mass %) | | | Phase |
| 15 | 1 | 32.92 | 67.04 | 0.04 | MoSi₂ |
| | 2 | 0.28 | 99.59 | 0.13 | Mo-substrate |
| 30 | 3 | 34.79 | 64.58 | 0.63 | MoSi₂ |
| | 4 | 0.20 | 99.41 | 0.39 | Mo-substrate |
| 60 | 5 | 35.18 | 64.14 | 0.68 | MoSi₂ |
| | 6 | 0.22 | 99.64 | 0.14 | Mo-substrate |

TABLE 2

| | | Si | Mo | Sn | |
|---|---|---|---|---|---|
| Time (min) | Area | (mass %) | | | Phase |
| 15 | 1 | 33.72 | 61.60 | 4.68 | MoSi₂ |
| | 2 | 0.30 | 98.90 | 0.79 | Mo-substrate |
| 30 | 3 | 34.33 | 63.07 | 2.60 | MoSi₂ |
| | 4 | 0.41 | 99.33 | 0.26 | Mo-substrate |
| 60 | 5 | 34.88 | 63.73 | 1.40 | MoSi₂ |
| | 6 | 0.13 | 99.22 | 0.65 | Mo-substrate |

TABLE 3

| | | Si | Mo | Sn | |
|---|---|---|---|---|---|
| Time (min) | Area | (mass %) | | | Phase |
| 15 | 1 | 33.09 | 60.49 | 6.43 | MoSi₂ |
| | 2 | 0.54 | 99.33 | 0.13 | Mo-substrate |
| 30 | 3 | 33.15 | 61.98 | 4.88 | MoSi₂ |
| | 4 | 0.17 | 99.60 | 0.23 | Mo-substrate |
| 60 | 5 | 34.06 | 63.72 | 2.22 | MoSi₂ |
| | 6 | 0.16 | 99.55 | 0.29 | Mo-substrate |

TABLE 4

| | | Si | Mo | Sn | |
|---|---|---|---|---|---|
| Time (min) | Area | (mass %) | | | Phase |
| 15 | 1 | 30.20 | 68.26 | 1.54 | MoSi₂ |
| | 2 | 0.45 | 98.98 | 0.57 | Mo-substrate |
| 30 | 3 | 30.72 | 65.93 | 3.35 | MoSi₂ |
| | 4 | 0.25 | 99.44 | 0.31 | Mo-substrate |
| 60 | 5 | 34.37 | 65.34 | 0.28 | MoSi₂ |
| | 6 | 0.35 | 99.23 | 0.43 | Mo-substrate |

In addition, among the obtained Mo alloy materials, the sample obtained at a bath temperature of 1000° C. and an immersion time of 60 minutes was subjected to a high-temperature oxidation test to investigate the high-temperature oxidation resistance. To be specific, first, a 10 mm square sample for the oxidation test was cut out from the sample. A portion of the sample thus cut out where the base material (Mo plate) was exposed was covered with a ceramic paste in order to prevent the influence of the high-temperature oxidation test. Next, the obtained sample was placed in a furnace (atmosphere: air) for the oxidation test, heated to 1150° C., held for 120 minutes, and then gradually cooled to room temperature. The heating rate was 20° C./min.

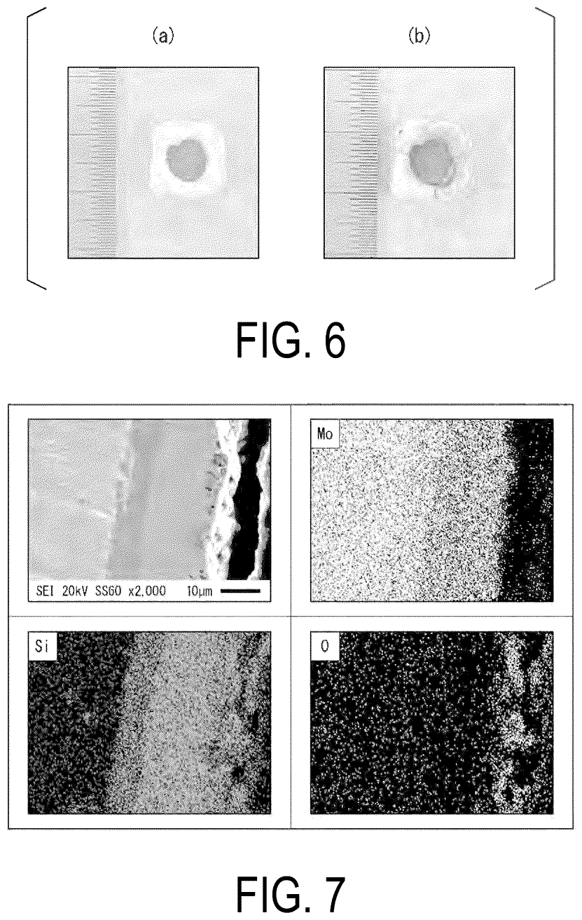

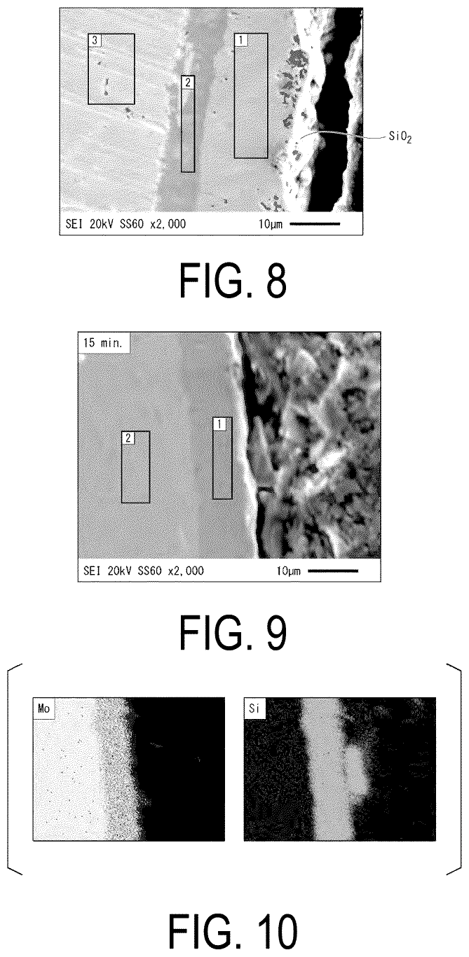

Photographs of the sample before and after the high-temperature oxidation test are shown in FIGS. 6(a) and 6(b). FIG. 6(a) shows a photograph of the sample before the test, and FIG. 6(b) shows a photograph of the sample after the test. FIG. 7 shows an SEM observation result (SEM image) and an element distribution analysis (element mapping) of the sample after the high-temperature oxidation test. In addition, energy dispersive X-ray analysis (EDS analysis) was performed on each of regions 1 to 3 of the SEM image shown in FIG. 7 to investigate the composition of each region, as shown in FIG. 8. The analysis results are shown in Table 5.

As is clear from FIGS. 6(a) and 6(b) as well as FIGS. 7 and 8, in the Mo alloy material manufactured by applying the present invention, the Mo silicide film does not peel off and remains as a clean film even after the high-temperature oxidation test, and therefore it is understood that the Mo alloy material to which the present invention is applied has excellent high-temperature oxidation resistance.

TABLE 5

| | Si | Mo | Sn | |
|---|---|---|---|---|
| Area | (mass %) | | | Phase |
| 1 | 35.00 | 64.38 | 0.62 | MoSi₂ |
| 2 | 13.46 | 86.48 | 0.05 | Mo₅Si₃ |
| 3 | 0.21 | 98.85 | 0.95 | Mo-substrate |

### Example 2

Next, in the same manner as in Example 1, using the immersion apparatus shown in FIG. 1, under an Ar gas atmosphere, Bi and Si were charged into a crucible (made of Al₂O₃) and the crucible was heated by a heater to prepare a treatment bath (molten Bi—Si alloy bath) having a composition of 98.0 mass % of Bi and 2.0 mass % of Si.

Next, a metallic Mo plate (50 mm in length, 10 mm in breadth, and 1 mm in thickness) was immersed in the prepared treatment bath with the bath temperature and immersion time adjusted as described below to form a Mo silicide film on the Mo plate, thereby obtaining a Mo-alloy material.

After the Mo silicide film was formed, the immersed Mo plate was lifted up from the treatment bath to remove the unnecessary bath adhering thereto, and then the Mo alloy material was taken out of the immersion apparatus and recovered.

### <Molten Bi—Si Alloy Bath>

Bath temperature: 1000° C.
Immersion time: 15 minutes, 60 minutes

Among the obtained Mo alloy materials, the Mo alloy material immersed for 15 minutes was subjected to SEM observation and element distribution analysis (element mapping) of the surface layer (including the Mo silicide film). The results are shown in FIGS. 9 and 10.

In addition, energy dispersive X-ray analysis (EDS analysis) was performed on each of regions 1 and 2 of the SEM image in FIG. 9 to investigate the composition of each region. The results are shown in Table 6.

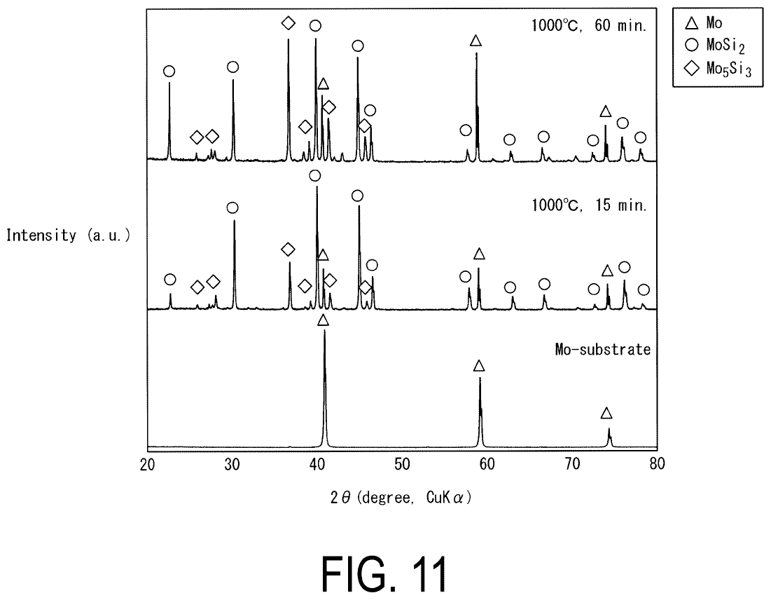

In addition, for each of the obtained Mo alloy materials, diffraction peaks were obtained by X-ray diffraction (XRD). Specifically, the surface of each of the obtained Mo alloy materials was subjected to XRD measurement. The XRD measurement was performed using CuKα as a radiation source at a measurement pitch of 0.02° in a 2θ range of 10° to 90° and at a measurement rate of 5°/min. The results are shown in FIG. 11.

As shown in FIGS. 9 to 11 and Table 6, it was found that a Mo silicide film was formed on the surface layer of the Mo alloy material produced by applying the present invention. As shown in FIG. 11, the presence of Mo₅Si₃ was confirmed as a result of the XRD measurement on the surface of each of the obtained Mo alloy materials, but as shown in Table 6, the Mo₅Si₃ was not detected by the EDS analysis of the region 1. This is considered to be because the thickness of the Mo₅Si₃ layer formed on the surface layer of the Mo alloy material is very small. However, as described above, it was confirmed by the XRD measurement (FIG. 11) that Mo₅Si₃ was generated in the surface layer of the Mo alloy material in Example 2.

TABLE 6

| Area | Si | Mo | Bi | Remarks |
|---|---|---|---|---|
| 1 | 35.31 | 64.30 | 0.39 | MoSi₂ |
| 2 | 0.16 | 99.84 | — | Mo-substrate |

### Example 3

Next, in the same manner as in Example 1, using the immersion apparatus shown in FIG. 1, under an Ar gas atmosphere, Cu and Si were charged into a crucible (made of Al₂O₃) and the curable was heated by a heater to prepare a treatment bath (molten Cu—Si alloy bath) having a composition of 73.5 mass % of Cu and 26.5 mass % of Si.

Next, a metallic Mo plate (50 mm in length, 10 mm in breadth, and 1 mm in thickness) was immersed in the prepared treatment bath with the bath temperature and immersion time adjusted as described below to form a Mo silicide film on the Mo plate, thereby obtaining a Mo-alloy material.

After the Mo silicide film was formed, the immersed Mo plate was lifted up from the treatment bath to remove the unnecessary bath adhering thereto, and then the Mo alloy material was taken out of the immersion apparatus and recovered.

### <Molten Cu—Si Alloy Bath>

Bath temperature: 1000° C.
Immersion time: 15 minutes, 30 minutes, 60 minutes

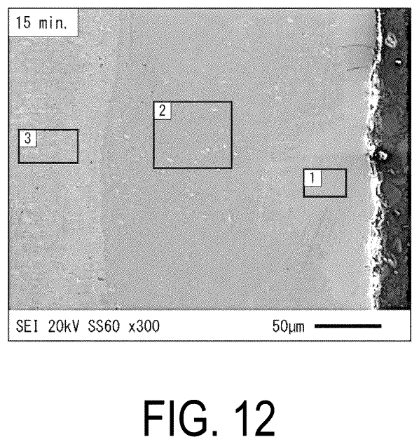

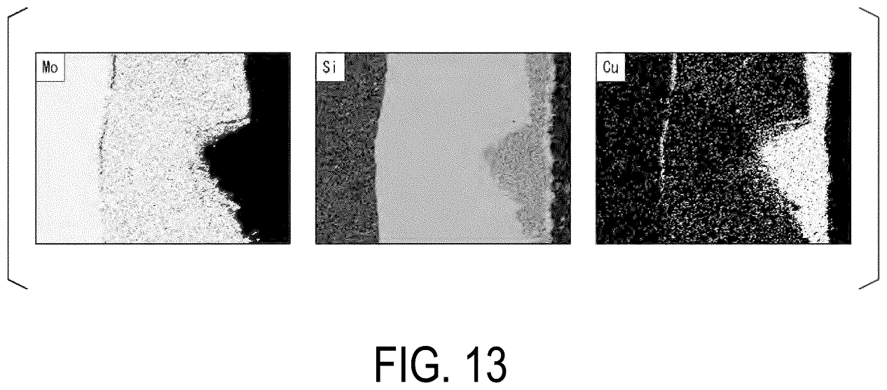

Among the obtained Mo alloy materials, the Mo alloy material immersed for 15 minutes was subjected to SEM observation and element distribution analysis (element mapping) of the surface layer (including the Mo silicide film). The results are shown in FIGS. 12 and 13.

In addition, energy dispersive X-ray analysis (EDS analysis) was performed on each of regions 1 to 3 of the SEM image in FIG. 12 to investigate the composition of each region. The results are shown in Table 7.

As shown in FIGS. 12 and 13 as well as Table 7, it was found that a Mo silicide film was formed on the surface layer of the Mo alloy material produced by applying the present invention. As shown in FIGS. 12 and 13, when a Cu—Si phase derived from the bath, which was not completely removed and remains, is formed on the outermost surface of the alloy material, the phase may be mechanically removed, for example.

TABLE 7

| Area | Si | Mo | Cu | Remarks |
|---|---|---|---|---|
| 1 | 12.78 | 0.25 | 86.97 | Cu—Si bath |
| 2 | 34.00 | 60.07 | 5.93 | MoSi₂ |
| 3 | 0.39 | 99.43 | 0.19 | Mo-substrate |

### Example 4

Next, in the same manner as in Example 1, using the immersion apparatus shown in FIG. 1, under an Ar gas atmosphere, Pb and Si were charged into a crucible (made of Al₂O₃) and the curable was heated by a heater to prepare a treatment bath (molten Pb—Si alloy bath) having a composition of 98.0 mass % of Pb and 2.0 mass % of Si.

Next, a metallic Mo plate (50 mm in length, 10 mm in breadth, and 1 mm in thickness) was immersed in the prepared treatment bath with the bath temperature and immersion time adjusted as described below to form a Mo silicide film on the Mo plate, thereby obtaining a Mo-alloy material.

After the Mo silicide film was formed, the immersed Mo plate was lifted up from the treatment bath to remove the unnecessary bath adhering thereto, and then the Mo alloy material was taken out of the immersion apparatus and recovered.

### <Molten Pb—Si Alloy Bath>

Bath temperature: 1000° C.
Immersion time: 15 minutes, 30 minutes, 60 minutes

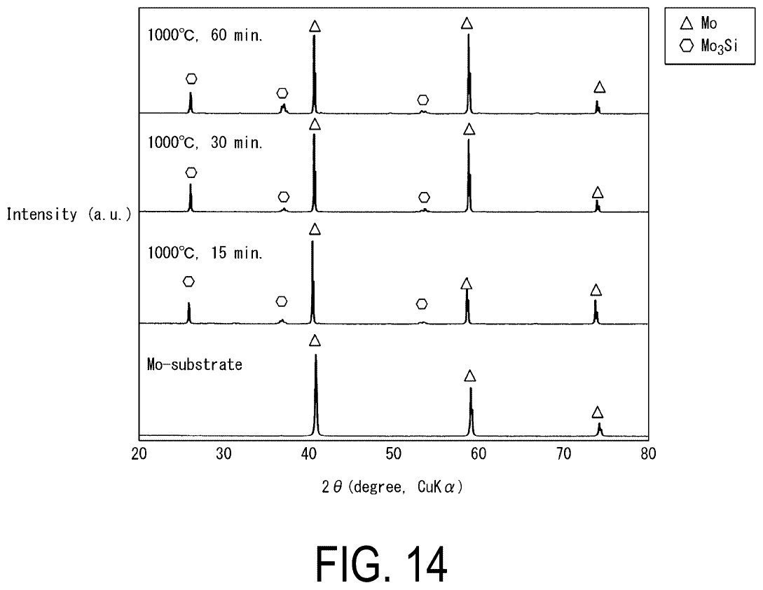

For each of the obtained Mo alloy materials, diffraction peaks were obtained by X-ray diffraction (XRD). Specifically, the surface of each of the obtained Mo alloy materials was subjected to XRD measurement. The XRD measurement was performed using CuKα as a radiation source at a measurement pitch of 0.02° in a 2θ range of 10° to 90° and at a measurement rate of 5°/min. The results are shown in FIG. 14.

As shown in FIG. 14, it was found that a Mo silicide film was formed on the surface layer of the Mo alloy material produced by applying the present invention.

### Example 5

Next, in the same manner as in Example 1, using the immersion apparatus shown in FIG. 1, under an Ar gas atmosphere, Sn and Si were charged into a crucible (made of Al₂O₃) and the curable was heated by a heater to prepare a treatment bath (molten Sn—Si alloy bath) having a composition of 98.8 mass % of Sn and 1.2 mass % of Si.

Next, a metallic W plate (50 mm in length, 10 mm in breadth, and 1 mm in thickness) was immersed in the prepared treatment bath with the bath temperature and immersion time adjusted as described below to form a W silicide film on the W plate, thereby obtaining a Mo-alloy material.

After the W silicide film was formed, the immersed W plate was lifted up from the treatment bath to remove the unnecessary bath adhering thereto, and then the W alloy material was taken out of the immersion apparatus and recovered.

### <Molten Sn—Si Alloy Bath>

Bath temperature: 1000° C.
Immersion time: 15 minutes, 30 minutes, 60 minutes

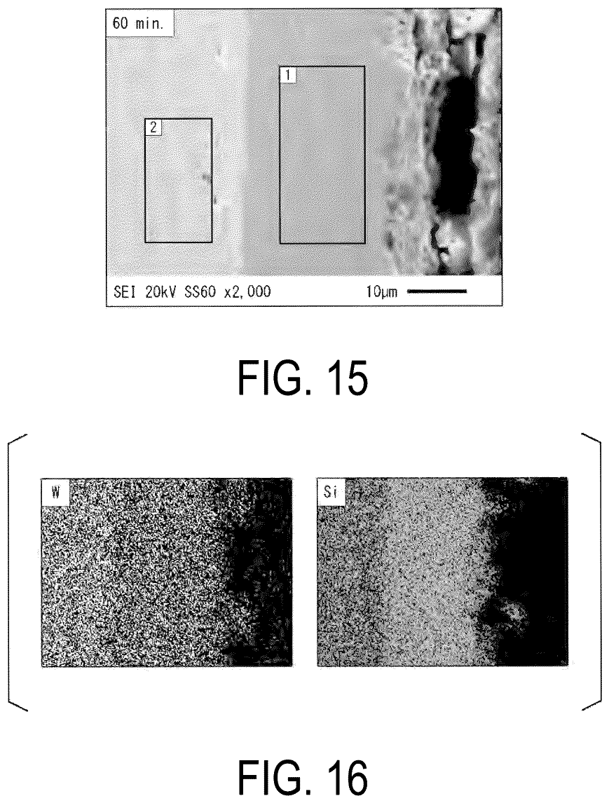

Among the obtained W alloy materials, the W alloy material immersed for 60 minutes was subjected to SEM observation and element distribution analysis (element mapping) of the surface layer (including the W silicide film). The results are shown in FIGS. 15 and 16.

In addition, energy dispersive X-ray analysis (EDS analysis) was performed on each of regions 1 and 2 of the SEM image in FIG. 15 to investigate the composition of each region. The results are shown in Table 8.

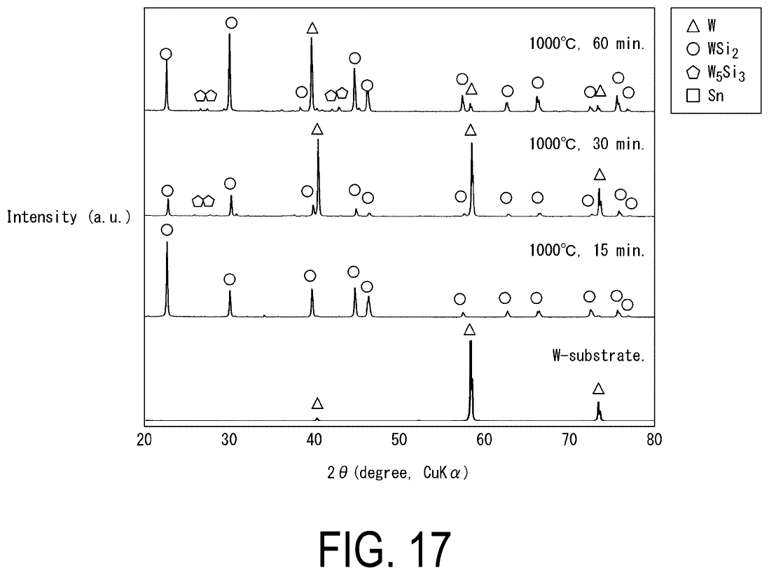

In addition, for each of the obtained Mo alloy materials, diffraction peaks were obtained by X-ray diffraction (XRD). Specifically, the surface of each of the obtained Mo alloy materials was subjected to XRD measurement. The XRD measurement was performed using CuKα as a radiation source at a measurement pitch of 0.02° in a 2θ range of 10° to 90° and at a measurement rate of 5°/min. The results are shown in FIG. 17.

As shown in FIGS. 15 to 17 and Table 8, it was found that a W silicide film was formed on the surface layer of the W alloy material produced by applying the present invention. As shown in FIG. 17, the presence of W₅Si₃ was confirmed as a result of the XRD measurement on the surface of each of the obtained W alloy materials, but as shown in Table 8, the W₅Si₃ was not detected by the EDS analysis of the region 1. This is considered to be because the thickness of the W₅Si₃ layer formed on the surface layer of the W alloy material is very small. However, as described above, it was confirmed by the XRD measurement (FIG. 17) that W₅Si₃ was generated in the surface layer of the W alloy material in Example 5.

TABLE 8

| Area | Si | W | Sn | Remarks |
|---|---|---|---|---|
| 1 | 22.35 | 77.57 | 0.08 | WSi₂ |
| 2 | 0.02 | 99.98 | — | W-substrate |

### Example 6

Next, in the same manner as in Example 1, using the immersion apparatus shown in FIG. 1, under an Ar gas atmosphere, Sn and Si were charged into a crucible (made of Al₂O₃) and the curable was heated by a heater to prepare a treatment bath (molten Sn—Si alloy bath) having a composition of 96.8 mass % of Sn, 1.2 mass % of Si, 1 mass % of Ag, and 1 mass % of Au.

Next, a metallic Mo plate (100 mm in length, 10 mm in breadth, and 30 μm in thickness) was immersed in the prepared treatment bath with the bath temperature and immersion time adjusted as described below to modify an entirety of the metallic Mo plate into a Mo silicide material.

The treatment bath was cooled and solidified while the obtained Mo silicide was immersed in the treatment bath, and thereafter, the Mo silicide was lifted up together with the solidified treatment bath, taken out to the outside of the immersion apparatus, and recovered. Since the obtained Mo silicide was thin, the Mo silicide was cut with the solidified treatment bath being attached thereto, to expose the plate thickness cross section, and the plate thickness cross section was subjected to SEM observation and the like described later.

### <Molten Sn—Si Alloy Bath>

Bath temperature: 1000° C.
Immersion time: 4 hours (240 minutes)

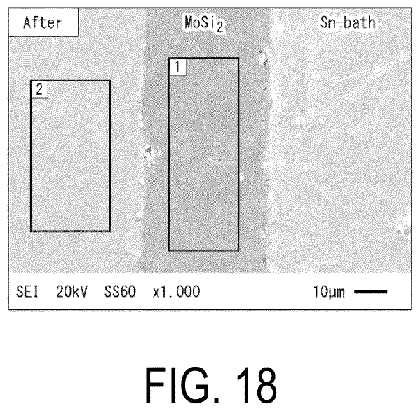

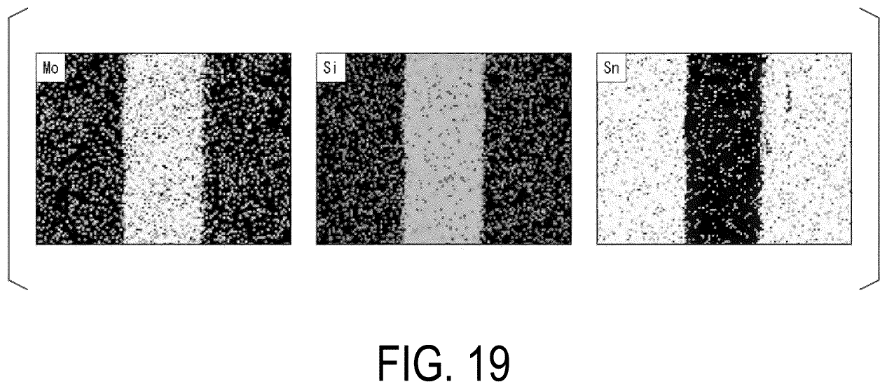

The obtained Mo silicide was subjected to SEM observation of a plate thickness cross section and element distribution analysis (element mapping). The results are shown in FIGS. 18 and 19.

In addition, energy dispersive X-ray analysis (EDS analysis) was performed on each of regions 1 and 2 of the SEM image in FIG. 18 to investigate the composition of each region. The results are shown in Table 9.

As shown in FIGS. 18 and 19 as well as Table 9, it was found that the entire metallic Mo plate can be modified to Mo silicide by applying the present invention.

TABLE 9

| Area | Si | Mo | Sn | Remarks |
|---|---|---|---|---|
| 1 | 34.85 | 63.49 | 1.66 | MoSi₂ |
| 2 | 0.72 | — | 99.28 | Sn-bath |

(mass %)

### INDUSTRIAL APPLICABILITY

The metal silicide of the present invention is excellent in high-temperature oxidation resistance. Therefore, it can be suitably used for a heating element, an electric resistor and the like.

1. A metal silicide comprising an element M, the metal silicide further comprising:
in mass %;
from 0.001 to 10% of an element X,
wherein the element X is one or more selected from the group consisting of Sn, Ag, Au, Bi, Pb, and Cu, and
the element M is Mo or W.

2. The metal silicide according to claim 1,
wherein the element X is Sn.

3. A method for producing the metal silicide according to claim 1, the method comprising:
an immersion step of immersing a Mo-based alloy material or a W-based alloy material in a treatment bath containing Si and the element X,
wherein the treatment bath has a bath temperature of from 200 to 1500° C., and
the treatment bath has a composition containing from 0.001 to 99.99 mass % of Si, with a remainder thereof being the element X.

4. The method for producing the metal silicide according to claim 3,
wherein the element X is Sn.

5. The method for producing the metal silicide according to claim 3, the method further comprising, before the immersion step, a pre-forming step of forming the Mo-based alloy material or the W-based alloy material.

6. An alloy material, comprising:
a base material; and
a film formed on a surface of the base material, the film comprising a metal silicide comprising an element M,
wherein the metal silicide comprises, in mass %, from 0.001 to 10% of an element X,
the element X is one or more selected from the group consisting of Sn, Ag, Au, Bi, Pb, and Cu,
the element M is Mo or W, and
the base material is a Mo-based alloy material or a W-based alloy material.

7. The alloy material according to claim 6,
wherein the element X is Sn.

8. A method for producing the alloy material according to claim 6, the method comprising an immersion step of immersing the base material in a treatment bath containing Si and the element X,
wherein the treatment bath has a bath temperature of from 200 to 1500° C., and
the treatment bath has a composition containing from 0.001 to 99.99 mass % of Si, with a remainder thereof being the element X.

9. The method for producing the alloy material according to claim 8,
wherein the element X is Sn.

10. The method for producing the alloy material according to claim 8, further comprising, before the immersion step, a pre-forming step of forming the base material.

11. A heating element comprising the metal silicide according to claim 1.

12. An electric resistor comprising the metal silicide according to claim 1.
